(19) United States
(12) Patent Application Publication
(10) Pub. No.: US 2013/0180314 A1
(43) Pub. Date: Jul. 18, 2013

(54) Apparatus for Measuring the Relative Speed of a Golf Putting Green

(71) Applicant: Steven J. Quintavalla, Branchburg, NJ (US)

(72) Inventor: Steven J. Quintavalla, Branchburg, NJ (US)

(21) Appl. No.: 13/349,761

(22) Filed: Jan. 13, 2012

(51) Int. Cl. G01N 19/02; A63B 57/00

(52) U.S. Cl. 73/9

(57) ABSTRACT

The measuring apparatus is in form of a bar having inclined parallel surfaces on each longitudinal side to define a ramp for rolling of a golf ball thereon with three notches in the ramps at different distances from the ends of the bar. Each notch is associated with a scaling factor to obtain the speed of a level green. The longest notch from one end of the bar is marked with a scaling factor of 1.00, the middle notch is marked with a scaling factor of 1.83, and the shortest notch from an end of the bar is marked with a scaling factor of 3.34.

This invention relates to an apparatus for measuring the relative speed of a golf putting green. More particularly, this invention relates to an improvement in an existing apparatus for measuring the relative speed of a golf putting green.

As is known, the relative speed of a golf putting green can be determined using a STIMPMETER® apparatus. In this regard, the STIMPMETER® apparatus allows one to make a standard measurement of—and place a numerical figure on—the speed of a putting green. Typically, the device is an extruded aluminum bar, 36 inches long, with a V-shaped groove extending along the entire length, a tapered end and a ball-release notch 30 inches from the tapered end (the end that rests on the ground). The underside of the tapered end is milled away to reduce bounce as a rolling ball makes contact with a green. In use, the bar is laid on a green or in a slightly inclined position, and a golf ball is placed in the, notch. The bar is then slowly raised until the ball starts to roll down the groove leaving the bar and coming to rest on the green. This procedure is repeated two more times from the same point on the green with two more golf balls.

Assuming the balls stop within a prescribed 8-inch limit, a tee is inserted in the green at the average stopping point of the three golf balls and the distance from the starting point is obtained.

The same procedure is repeated by positioning the end of the bar at the tee and rolling the three golf balls back toward the initial starting point to obtain the distance of the average stopping point of the golf balls from the tee. The two obtained distances are averaged and recorded as the speed of the green.

The STIMPMETER® apparatus requires a level green and an area of approximately 10 feet by 10 feet. However, such a large flat area may not exist on many greens.

Accordingly, it is an object of the invention to be able to measure the speed of a green within a relatively small area of the green.

It is another object of the invention to provide an improved STIMPMETER® device for measuring the speed of a green.

Briefly, the invention provides an apparatus for measuring the speed of a golf green comprised of an elongated body in the form of a bar having a pair of oppositely inclined parallel surfaces on each longitudinal side to define a ramp for rolling of a golf ball thereon and at least one notch in each ramp for positioning a golf ball therein.

In accordance with the invention, each notch is spaced from one end of the body at a different distance from the other notches.

The procedure for using the improved apparatus is the same as for a standard STIMPMETER® apparatus except that for small level areas of a green, i.e. less than 10 feet by 10 feet, each ball is rolled from a lower notch.

These and other objects and advantages of the invention will become more apparent from the following detailed description taken in conjunction with the drawings wherein:

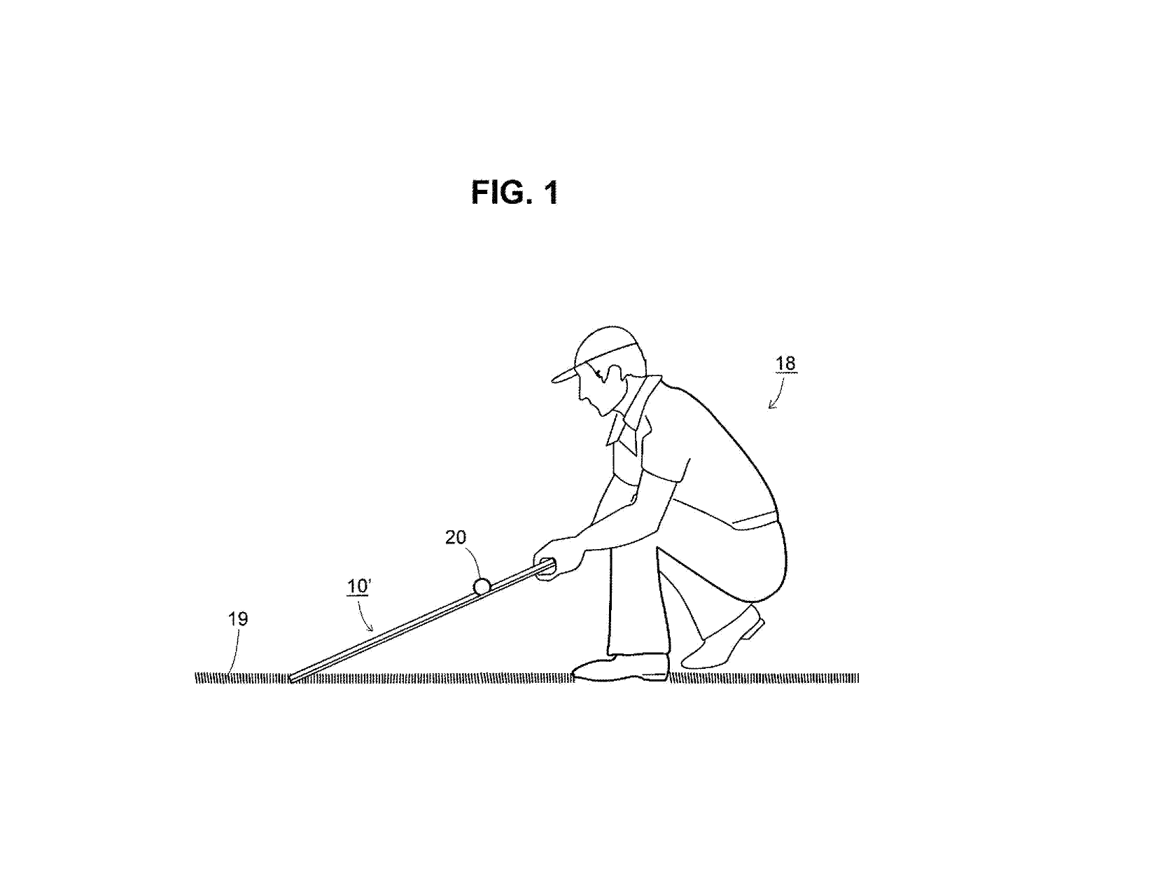

FIG. 1 is a schematic representation of an apparatus for measuring the speed of a golf green in accordance with the invention in use;

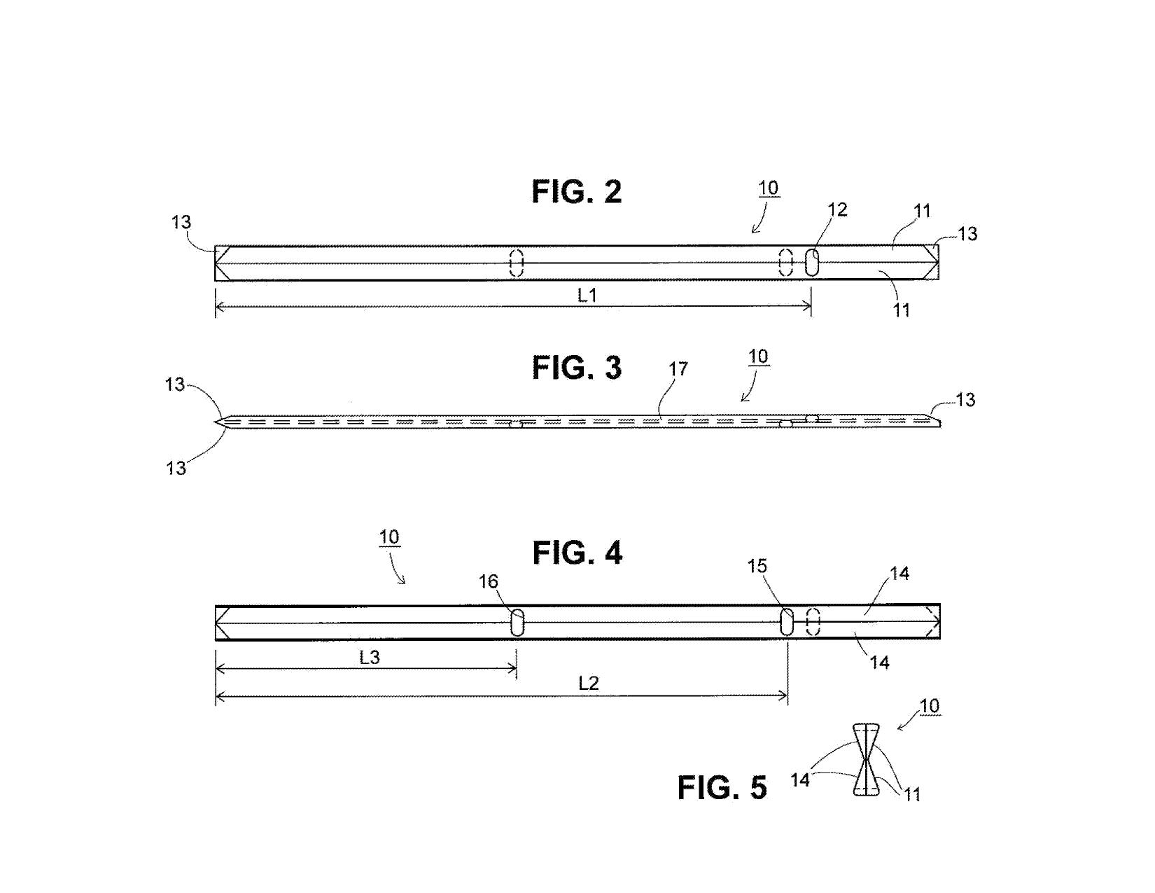

FIG. 2 is a view of one side of the measuring apparatus of FIG. 1;

FIG. 3 is a view of a lateral side of the measuring apparatus of FIG. 1;

FIG. 4 is a view of the opposite side of the measuring apparatus from FIG. 2;

FIG. 5 is an end view of the measuring apparatus of FIG. 1; and

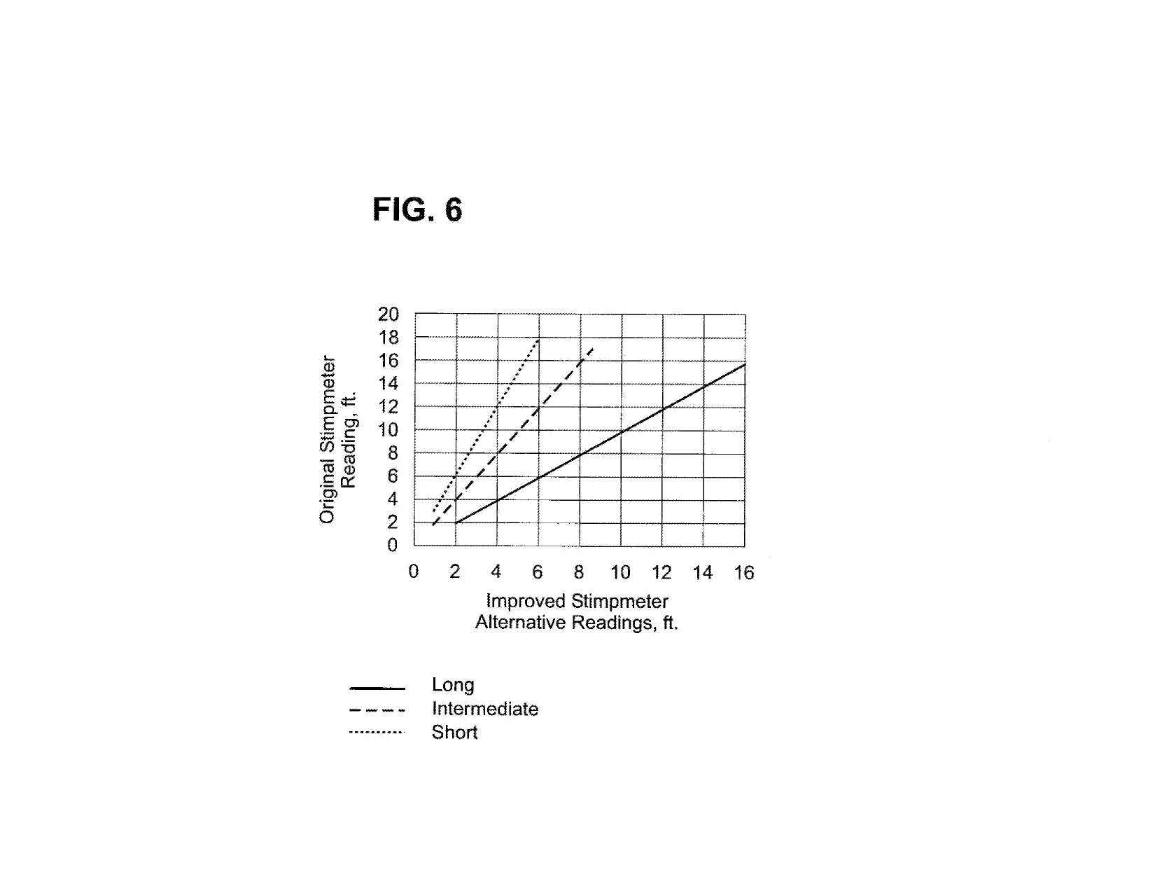

FIG. 6 illustrates a chart of test results using the measuring apparatus of FIG. 1.

Referring to FIG. 2, the apparatus for measuring the speed of a golf green comprises an elongated body 10 in the form of an aluminum bar having a length of 36 inches, a width of 1.75 inches and a thickness of 0.625 inches at a lateral edge. One longitudinal side of the body 10 has a pair of oppositely inclined parallel surfaces 11 that define a ramp for rolling of a golf ball thereon and that define an included angle of 145° (see FIG. 5). This side of the body 10 also has a notch 12 spaced a predetermined distance (L1) from the end of the body 10, i.e. a distance of 29.38 inches.

The notch 12 is of conventional size, e.g. having a width of 1.25 inches across the body 10 and a height of 0.594 inches longitudinally of the body 10.

The body 10 has a tapered surface 13 at each end to allow the body to lie flat against a level green surface.

Referring to FIG. 4, the second longitudinal side of the body 10 has a pair of oppositely inclined parallel surfaces 14 defining a second ramp for rolling of a golf ball thereon as well as two notches 15, 16. Each of these notches 15, 16 is of the same size as the notch 12 on the opposite side of the body 10 and is spaced aₜ a different distance from the end of the body 10 form the first notch 12. As shown, one notch 15 is spaced a distance (L2) of 14.69 inches from one end of the body and the other notch 16 is spaced half that distance (L3) from the opposite end of the body 10, i.e. a distance of 7.345 inches. Thus, one notch 12 provides a standard notch as in a STIMPMETER® apparatus, a second notch 15 is located one-half the distance of the standard notch 12 and the third notch 16 is located one-quarter the distance of the standard notch 12.

Referring to FIG. 3, the body 10 has a lateral side 17 that is of uniform thickness throughout the length thereof.

Referring to FIG. 6, testing has shown that using the shorter heights associated with the alternative notches 15, 16 can be used to predict the traditional Stimpmeter reading. According to the chart of FIG. 6, the “shortest” ramp, i.e. the section of ramp from the notch 16, requires the user to multiply the results by about 3.34 and the “middle” length ramp, i.e. the ramp section from the notch 15, requires the user to multiply the results by about 1.83 in order to obtain the “original” Stimpmeter reading.

The body 10 is also marked with a plurality of scaling factors on a flat lateral side 17 (not shown), each scaling factor corresponding to a respective one of the notches 12, 15, 16.

For example, the standard notch 12 is marked with a scaling factor of 1.00, the middle notch 15 is marked with a scaling factor of 1.83, and the shortest notch 16 is marked with a scaling factor of 3.34.

The body 10 may also have a scale (not shown) for measuring ball roll distance running on the opposite flat lateral side 17 from the scaling factors.

Referring to FIG. 1, the body 10 is manually employed by a user 18 to measure the speed of a green 19 by inclining the body with a golf ball 20 in a selected notch 12, 15, 16 of the body 10. For a large area of level green, i.e. of at least 10 feet by 10 feet, each golf ball of a set of three golf balls is positioned in and rolled from the single notch 12 located on one side of the body 10 in accordance with the standard procedure for a STIMPMETER® apparatus.

For use on a green of a small level area, i.e. of less than 10 feet by 10 feet; the body 10 is turned over to present a shorter ramp down which a ball may roll. The body 10 is reversible so that a ball 20 may be rolled from one of two different heights depending on the smallness of the green area being tested.

For a relatively small area of level green, the average distance resulting from a ball 20 being rolled down the body 10 from the “shortest” ramp 16 is obtained using the standard steps for a standard STIMPMETER® apparatus. This averaged distance is then multiplied by a scaling factor of 3.34 to obtain the speed of the green.

For a larger size of level green, the average distance resulting from a ball 20 being rolled down the body 10 from the “middle” ramp 15 is obtained using the standard steps for a standard STIMPMETER® apparatus. This averaged distance is then multiplied by a scaling factor of 1.83 to obtain the speed of the green.

The invention thus provides a measuring apparatus that is able to measure the speed of a level green within a relatively small area of the green.

The invention further provides an improved STIMPMETER® apparatus for measuring the speed of a green using a relatively small level area of the green.

What is claimed is:

1. An apparatus for measuring the speed of a golf green comprising
an elongated body having a pair of oppositely inclined parallel surfaces on one longitudinal side defining a first ramp for rolling of a golf ball thereon, a pair of oppositely inclined parallel surfaces on an opposite longitudinal side defining a second ramp for rolling of a golf ball thereon, a first notch in said first ramp for positioning a golf ball therein, and a second notch in said second ramp for positioning a golf ball therein.

2. An apparatus as set forth in claim 1 wherein said first notch is spaced from one end of the body at a first distance and said second notch is spaced from said one end of said body at a second distance different from said first distance.

3. An apparatus as set forth in claim 2 further comprising a scaling factor marked on said body.

4. An apparatus as set forth in claim 1 further having a third notch in said second ramp spaced from said second notch therein.

5. An apparatus as set forth in claim 4 wherein said first notch is spaced from one end of the body at a first distance, said second notch is spaced from said one end of said body at a second distance different from said first distance and said third notch is spaced from said one end of said body at a third distance different from each of said first distance and said second distance.

6. An apparatus as set forth in claim 5 further comprising a plurality of scaling factors marked on said body, each said scaling factor corresponding to a respective one of said first notch, said second notch and said third notch.

7. An apparatus as set forth in claim 1 wherein said a pair of oppositely inclined parallel surfaces defining a first ramp define an included angle of 145°.

8. An apparatus as set forth in claim 1 having a scale for measuring ball roll distance.
